(19) United States
(12) Patent Application Publication
(10) Pub. No.: US 2016/0016735 A1
(43) Pub. Date: Jan. 21, 2016

(54) CONVEYING SYSTEM

(71) Applicant: EISENMANN SE, Böblingen (DE)

(72) Inventors: Dietmar Binder, Holzgerlingen (DE); Ulrich Hofbauer, Gaeufelden (DE); Maximilian Hoyer, Tuebingen (DE); Reiner Starz, Weil der Stadt (DE)

(21) Appl. No.: 14/769,526

(22) PCT Filed: Feb. 11, 2014
(86) PCT No.: PCT/EP2014/000370

§ 371 Date: Aug. 21, 2015

(30) Foreign Application Priority Data
Feb. 22, 2013 (DE) 10 2013 003 057.9

(51) Int. Cl. B65G 37/00; B05C 9/14

(52) U.S. Cl. CPC B65G 37/00; B05C 9/14

(57) ABSTRACT

An installation for the surface treatment of articles has at least two treatment stations and a conveying system which may convey the articles through a respective treatment station. The conveying system has a main conveyor, by means of which articles can be conveyed, without being treated, on a main circular route. The treatment stations are arranged along the main circular route, and the conveying system has a respective station conveying system for each of the at least two treatment stations. The station conveying system can be used to convey articles from the main circular route to the treatment station, through the treatment station and from the treatment station back again onto the main circular route, such that vehicle wheels can be conveyed optionally, by means of a station conveying system, through the associated treatment station or, by means of the main conveyor, past the treatment station.

The invention relates to an installation for the surface treatment of articles, said installation having:
a) at least two treatment stations;
b) a conveying system by means of which the articles can be conveyed through a particular treatment station.

In installations of this kind which are known from the market, articles are conveyed through successive treatment stations belonging to a treatment installation, in which stations the articles are provided with a surface coating in a number of treatment steps. Articles of this kind which are to be treated consist, for example, of parts of vehicle bodies or vehicle wheels. In the present case, the invention will be explained using the example of vehicle wheels.

In this connection, so-called “spindle-type conveyors” have become established as the conveying systems for vehicle wheels and are often constructed in such a way that all the vehicle wheels always pass through all the treatment stations one after another.

Now there are vehicle wheels which differ through the fact that they are intended to receive mutually differing treatment steps or have to pass through the treatment stations which are present in a painting installation in a different sequence. For example, ordinary wheels are given a different treatment from special wheels. Special wheels consist, for example, of so-called “multicolour wheels” which are to be given a multicolour paint. Other special wheels consist, for example, of gloss-turned wheels which have a high-gloss surface which is obtained by mechanical machining in the form of gloss-turning.

Treatment, in one and the same painting installation, of vehicle wheels which differ in this way is usually not possible, since the sequence of steps in a conveyor cannot be adapted without difficulty, and only by modifications in design.

An installation of the kind initially mentioned, which is the starting point here, is known from EP 2 024 102 B1. In said installation, a number of conveyors are present which pass through various treatment stations and are connected to one another, from the materials-handling point of view, by transfer arrangements. As soon as a vehicle wheel is located on a specific conveyor, it also automatically passes through the associated treatment station through which the particular conveyor travels. However, the installation described in EP 2 024 102 B1 offers only two treatment sequences which are coordinated with normal rims, on the one hand, and with special rims in the form of gloss-turned rims, on the other. In that installation, an unrestricted sequence of quite different treatment steps, or even repeated transition through one and the same treatment station without having to first pass through another treatment station, is not possible.

The object of the invention is therefore to provide an installation of the kind initially mentioned, which permits particular flexibility, referred to the sequence of individual treatment steps.

In an installation of the kind initially mentioned, this object is achieved through the fact that:
c) the conveying system comprises a main conveyor by means of which articles can be conveyed, without being treated, over a main circular route;
d) the treatment stations are arranged along the main circular route;
e) the conveying system comprises an individual station conveying system for each of the at least two treatment stations, by means of which system articles can be conveyed from the main circular route to the treatment station, through the treatment station, and from the treatment station back onto the main circular route again, such that:
f) articles can be conveyed selectively, by means of a station conveying system, through the associated treatment station or, by means of the main conveyor, past said treatment station.

According to the invention, the treatment stations are arranged parallel to the main conveyor and can each be fed separately via the station conveying systems, starting from the main conveyor, with articles which are to be treated, e.g. vehicle wheels. In the context of the main conveyor, “without being treated” means that the vehicle wheels are not treated and do not pass through any treatment arrangement or the like when they are being conveyed with the aid of the main conveyor. As a result, each vehicle wheel is able to pass through the selected treatment stations in an individual sequence, i.e. in any desired combination, order and repeat procedure.

It is thus possible, for example, for a vehicle wheel to be initially guided past a first treatment station and fed to a second treatment station, whereupon said vehicle wheel arrives, after this second treatment station, at the first treatment station again and can then be treated at that point. All in all, an installation of this kind has high flexibility and the process cycle can always be varied and adapted, taking account of the nature of the treatment stations that are present, without greater structural measures being necessary for that purpose.

The term “main circular route” should be understood to mean that the route has a self-contained path.

It is favourable if a station conveying system comprises a handling arrangement by means of which articles can be transferred from the main conveyor to the treatment station. The treatment stations often have their own working atmosphere prevailing within them, which atmosphere can thus be kept separate from the main conveyor. The handling arrangement is preferably an articulated-arm robot.

In a particularly preferred manner, the main conveyor is a “power-and-free” conveyor. Conveyors of this kind are known from the prior art and need no further explanation.

If a treatment station comprises a cooling zone, it is particularly advantageous if the station conveyor of the said treatment station comprises a branch conveyor which connects the cooling zone, from the materials-handling point of view, to the main conveyor.

It is favourable if at least one pre-treatment station is present. If, for example, various vehicle wheels require different pre-treatments, either a single pre-treatment station may be designed for variable pre-treatment steps, or else two or more pre-treatment stations may also be present, which are each adapted to a specific kind of vehicle wheels. As a result of the design of the installation, it is possible to call, in a targeted manner, at the particular pre-treatment station which is required, without the particular vehicle wheel having to pass through other pre-treatment stations which are present.

Furthermore, it is advantageous if at least one powder-painting station is present, in addition or as an alternative. If a number of powder-painting stations, particularly for different-coloured powder paints, are present, the flexibility is increased still further, for example particularly with respect to the multicoloured wheels mentioned.

The installation is advantageously made complete if, in addition or as an alternative, at least one wet-painting station is present. In this case, too, one or more wet-painting stations may be provided.

In corresponding manner, it is favourable if, in addition or as an alternative, at least one top-coating station is present.

If, in addition or as an alternative, at least one machining station is present in which the articles can be machined mechanically, it is possible to carry out, not only coating operations but also mechanical work on the articles.

It is favourable, particularly in the case of vehicle wheels, if the machining station is a gloss-turning station.

If at least one separate cooling station is present, the articles may advantageously be cooled separately again, if this is necessary, without having, for that purpose, to pass through a treatment station which is actually intended for coating or machining the articles. Instead of, or in addition to, a cooling station, a pre-heating station may also be provided.

As initially explained, it is advantageous if the installation is designed particularly for treating vehicle wheels.

One example of embodiment of the invention will now be explained in greater detail below with the aid of the drawings, in which:

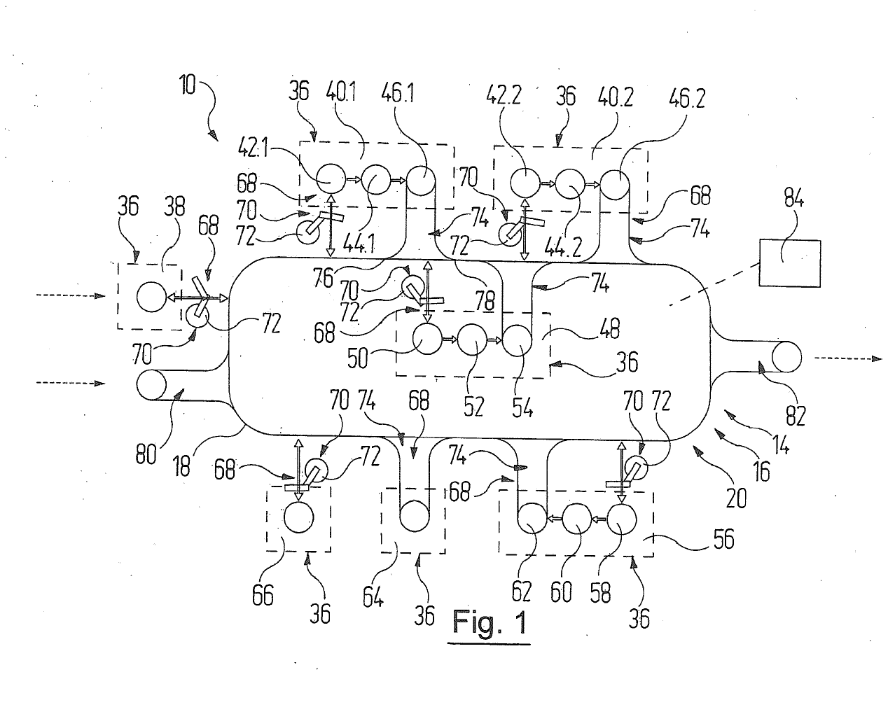

FIG. 1 shows a diagrammatic overall layout of a surface treatment installation according to the invention for vehicle wheels;

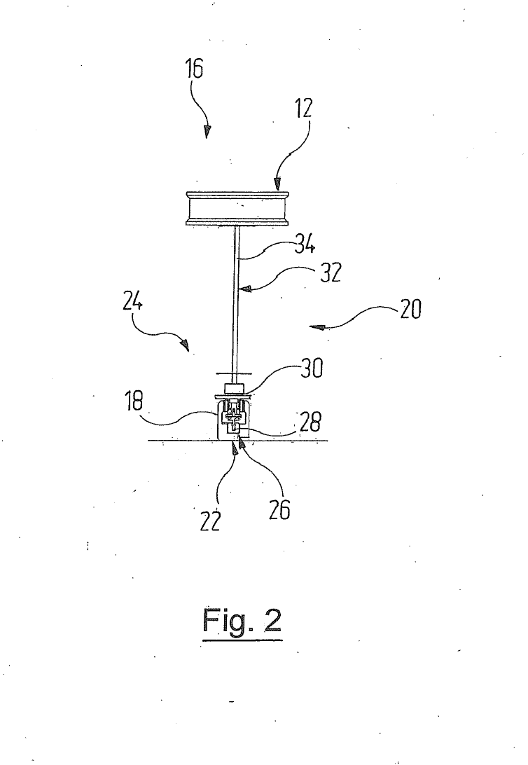

FIG. 2 shows a section through a floor-guided spindle-type conveyor.

FIG. 1 shows the overall layout of an installation 10 for the surface treatment of articles, which is designed, for example, for vehicle wheels 12. In said installation 10 it is possible to produce both normal wheels and special wheels, such as were initially described.

The installation 10 comprises a conveying system 14 having a main conveyor 16 by means of which vehicle wheels 12, which are shown only in FIG. 2, can be conveyed, without being treated, in a closed circuit over a main circular route 18. As was initially mentioned, “without being treated” means that the vehicle wheels 12 are not treated in the process and do not pass through any treatment arrangement or the like and are consequently only conveyed by the main conveyor 16. The main circular route 18 may also have a path, for example a winding or even meander-shaped path, that differs from a simple circular guide which is illustrated in FIG. 1.

In the present example of embodiment, the main conveyor 16 is constructed as a floor-guided spindle-type conveyor 20 which is shown in section in FIG. 2. For this purpose, the main conveyor 16 comprises a carrying rail 22 which is anchored to the floor and on which a plurality of transporting trucks 24 can be conveyed. For this purpose, there is routed along the carrying rail 22, in the present example of embodiment, an endless driving means 26 which in this case is constructed as an endless driving chain 28. Running on the carrying rail 22, at the top, is a chassis 30 of the transporting truck 24, which chassis is coupled to the endless driving chain 28.

Said chassis 30 comprises, in a manner which is known per se, running and guide rollers which are not specifically indicated but by means of which said chassis runs along on the carrying rail 22 and which stabilise the transporting truck 24 against tilting in the direction of transport and also against tilting to the side.

The transporting truck 24 conveys with it a carrying arrangement 32 for the vehicle wheels 12 which, in the present example of embodiment, is constructed as a wheel spindle 34 and which, in a manner which is known per se, supports a vehicle wheel 12 which is to be treated.

Now there are arranged along the main circular route 18 a number of treatment stations 36 through which the vehicle wheels 12 are able to pass. Generally speaking, these may be treatment stations 36 for coating the vehicle wheels with colour-imparting powder paints or wet paints or even with special paints, such as, for example, anti-corrosion paints or the like, and also stations for drying or cooling or even mechanically machining the vehicle wheels 12. The treatment stations 36 may be arranged in any desired order, referred to their function, and may also be located at different distances from the main circular route 18. Optionally, it is even possible for different treatment stations 36 to be accommodated on different tiers.

If, in the context of a coating operation, what is under discussion in the present case is “drying”, this means all the operations in which the coating, in particular a paint, can be brought to the point of hardening, whether this is now done by expelling solvents or by cross-linking of the coating substance. Thus, for example, even irradiation with electromagnetic radiation, such as UV light for example, counts as a drying operation.

The following description of the treatment stations 36 which are present is merely given as an example; in practice, the installation 10 for the surface treatment of vehicle wheels 12 may contain more or fewer treatment stations 36, and even ones of a different kind, than those that will be described below.

The installation 10 comprises a pre-treatment station 38 in which vehicle wheels 12 which are to be treated are pre-treated in a number of treatment steps which are not specifically illustrated here. In the process, the vehicle wheels 12 are, for example, degreased, cleaned, dried and optionally cooled in a cooling zone.

Also present are a first and a second powder-painting station 40.1, 40.2 which, in turn, comprise an application booth 42.1, 42.2 in which a powder paint can be applied, a drier 44.1, 44.2 and a cooling zone 46.1, 46.2, through which the vehicle wheels 12 pass within the particular powder-painting station 40.1, 40.2. For example, a grey powder primer may be applied in the first powder-painting station 40.1, and a coloured powder coating in the second powder-painting station 40.2.

The installation 10 further comprises a wet-painting station 48 having an application booth 50 in which a wet paint can be applied, a drier 52 and a cooling zone 54. Instead of one painting booth 50, the wet-painting station 48 may also comprise a number of painting booths; for example it is possible to apply first a silver paint and then a clear lacquer to the vehicle wheels 12.

Located on the main conveyor 14 as an additional treatment station is a top-coating station 56 which, in this case, is an acrylic paint station and, in turn, comprises an application booth 58 for acrylic paint, a drier 60 of its own, and a cooling zone 62 of its own.

By way of an example, the installation 10 also comprises another separate cooling station 64, which forms a separate cooling zone. Instead of the separate cooling station 64, or in addition to the latter, a separate pre-heating station may also be present, in which vehicle wheels 12 to be treated can be heated up to a temperature which is desired for further treatment. Also arranged in the installation 10 is a separate treatment station 66 in which vehicle wheels 12 can be mechanically machined. Said treatment station 66 is, in particular, a gloss-turning station in which the vehicle wheels can be gloss-turned in a manner which is known per se.

For each of the treatment stations 36 under consideration, the conveying system 14 comprises an individual station conveying system 68 by means of which vehicle wheels 12 can be conveyed from the main circular route 18 to the treatment station 36, through said treatment station 36, and from the latter back to the main circular route 18 again.

For this purpose, the station conveying systems 68 of all the treatment stations 36, with the exception of the separate cooling station 64, each comprise a handling arrangement 70 which, in the present example of embodiment, is constructed, in each case, as an articulated-arm robot which is designated by 72. Articulated-arm robots of this kind are known per se and therefore need no further explanation. With the aid of the articulated-arm robot 72, vehicle wheels 12 can be transferred from the main conveyor 16 to the treatment stations 36, that is to say, in the present case, to the respective application booths 42.1, 42.2, 50 and 58 of the treatment stations 36 and to the machining station 66.

By means of the station conveying systems 68, the vehicle wheels 12 are conveyed, within a particular treatment station 36, from the respective application booth 42.1, 42.2, 50 and 58 to the respective drier 44.1, 44.2, 52 or 60 which is present, and from there to the respective cooling zone 46.1, 46.2, 54 or 62. For this purpose, further handling units for example, such as robots for example, are present within the treatment stations 36.

For the cooling zones 46.1, 46.2, 54 and 60, the station conveying systems 68 each comprise a branch conveyor 74, which branch conveyors branch off from the main conveyor 16 as a side arm via a respective points unit 76, are routed through the respective cooling zone 46.1, 46.2, 54 and 60 of the treatment stations 36, and from there back to the main conveyor 16 again via a further points unit 78. In the case of the branch conveyor 74 of the powder-painting station 40.1, the points units 76 and 78 are merely provided with reference numerals. Thus one branch conveyor 74, in each case, connects one of the cooling zones 46.1, 46.2, 54 and 60 of the treatment stations 36, from the materials-handling point of view, to the main conveyor 16 in each case.

After the vehicle wheels 12 in the corresponding treatment stations 36 have passed through the respective drier 44.1, 44.2, 52 or 60, they are transferred, within the respective treatment station 36, to the associated branch conveyor 74 and thus to the cooling zone 46.1, 46.2, 54 and 60, pass through said respective cooling zone 46.1, 46.2, 54 and 60 and then pass, in the cooled state, back to the main conveyor 16 again on the main circular route 18.

In the case of the separate cooling station 64, its station conveying system 68 as a whole is formed by a branch conveyor 68 of this kind. In the machining station 66, the handling arrangement 70 which is present forms, as a whole, the associated station conveying system 68, just as in the pre-treatment station 38.

As can be seen with the aid of the cooling station 64 or the machining station 66, one treatment station 36 may also cover only a single treatment operation. In this case, the associated station conveying system 68 conveys the vehicle wheels 12 through the treatment station 36 by conveying said vehicle wheels 12 into the treatment station 36 and out of the latter again. For this purpose, said treatment station 36 may even have only a single access.

In a modification which is not specifically shown, a particular station conveying system 68 of a treatment station 36 may also be formed, as a whole, by a branch conveyor 74 of this kind. Consequently, in the case of the powder-painting station 40.1, the branch conveyor 74 then guides the vehicle wheels 12 from the main circular route 18 of the main conveyor 16 into the application booth 42.1, from there into the drier 44.1 and onwards into the cooling zone 46.1, from where said vehicle wheels pass back onto the main circular route 18 again.

In another modification, which is likewise not shown, a branch conveyor 74 may also lead from the main circular route 18 directly to one of the driers 44.1, 44.2, 52 or 60 of the stations 40.1, 40.2, 48 or 56, from there into one of the cooling zones 46.1, 46.2, 54 or 62, which are located downstream in each case, and back to the main circular route 18 again.

Also branching off from the main conveyor 16 are another receiving conveyor 80 and a delivery conveyor 82, which are set up like the branch conveyors 74 but serve to receive vehicle-wheel blanks which are to be treated, or to deliver vehicle wheels 12 whose treatment has been completed, this being illustrated by arrows shown in broken lines. The giving-up of the vehicle-wheel blanks to be treated may optionally also take place directly via the pre-treatment station 38.

The installation 10 and its individual conveying systems and conveying units 18, 68, 70, 80 and 82 are activated and coordinated by a central control system 84, which is only shown diagrammatically, so that it is optionally possible to guarantee even a so-called “spindle-synchronous” cycle in the treatment of the vehicle wheels 12.

It is now possible to treat different vehicle wheels 12 in the installation 10 in individual treatment cycles. The vehicle wheels 12 can be conveyed to individual treatment stations 36 selectively on the main conveyor 16, and conveyed into said stations by means of their station conveying system 68, in order to be treated within them. If vehicle wheels 12 are not intended to pass through a certain treatment station 36, they can be guided past such a treatment station 36 on the main conveyor 16.

It is also possible for vehicle wheels 12 to be fed to the same treatment station 36 two or more times in succession, so that said vehicle wheels 12 receive the same treatment two or more times in succession. Normal wheels, for example, pass through the following treatment steps:

The appropriate vehicle wheels 12 are initially pre-treated in the pre-treatment station 38, as has been explained above. They then pass, on the main conveyer 16, to the powder-painting station 40.1 where they are received by the latter's station conveying system 68 with the aid of the articulated-arm robot 72 and transferred into the application booth 42.1. After being coated with powder paint at that point, the vehicle wheels 12 pass through the drier 44.1 of the powder-painting station 40.1 and reach the latter's cooling zone 46.1. There they are transferred onto the branch conveyor 74 and then pass, in the cooled state, back onto the main conveyor again.

The vehicle wheels 12 are now conveyed by means of the main conveyor 16 to the wet-painting station 48, where they are transferred, by the articulated-arm robot 72 of the associated station conveying system 68, from the main conveyor 16 into the application booth 50. Within the wet-painting station 48, the vehicle wheels 12 then pass through the drier 52 located therein and the cooling zone 54 located therein, from which cooling zone they are conveyed back to the main conveyor 16 again by means of the branch conveyor 74 of the wet-painting station 48.

After this, the vehicle wheels 12 which have been coated in this way are then conveyed, on the main conveyor 16, to the acrylic paint station 56, in whose application booth 58 they are sealed with acrylic paint which is baked on in the associated drier 60, whereupon said vehicle wheels 12 are cooled in the cooling zone 62 and then pass onto the main conveyor 16 again. On the latter, the normal wheels, which are now finished, are conveyed to the delivery conveyor 82, from which they are removed and fed to their subsequent destination.

Special wheels are now able to pass through other treatment steps in a different order within the same installation 10.

For example, so-called “multicolour wheels” 12 can be pre-treated in the pre-treatment station 38 and then provided with paints of different kinds and different colours in various powder-painting stations 40.1, 40.2 and/or the wet-painting station 48. In this case too, a final covering with acrylic paint can again take place within the acrylic-painting station 56.

If different vehicle wheels 12 which are to be treated, for example special wheels and normal wheels, each have to be given a different pre-treatment, the installation 10 may also comprise, in addition to the pre-treatment station 38, one or more additional pre-treatment stations which are adapted to the pre-treatments necessary for specific vehicle wheels.

So-called “high-gloss” wheels, on the other hand, are also mechanically machined in the machining station 66 in an intermediate step between the individual painting operations. In this case, the vehicle wheels are gloss-turned, particularly in a gloss-turning arrangement, in a manner which is known per se. After the gloss-turning operation, the vehicle rims 12 may optionally be initially cleaned and degreased again in the pre-treatment station 38 before the gloss-turned areas of the vehicle wheel 12 are coated and sealed in the powder-painting station or stations 40.1, 40.2 or the wet-painting station 48 and the acrylic-painting station 56.

The arrangement of the treatment stations 36 corresponds, overall, to a parallel arrangement along the main conveyor 16, so that vehicle wheels 12 can be fed to the treatment stations 36 in parallel. As a result, all the treatment stations 36 can be called at, and fed with vehicle wheels 12, independently of the rest of the treatment stations 36. Thus, different vehicle wheels 12 can pass through various treatment stations 36 in alternative sequences within one and the same installation 10.

In the event of the treatment stations 36 operating at full capacity, but more vehicle wheels 12 being located on the main conveyor 16, the latter can also serve as a buffer, through the fact that vehicle wheels 12 which have still to be treated are initially guided past the required treatment station 36 and guided in circulation on the main circular route 18 again until they arrive at the desired treatment station 36 once more.

1. Installation for the surface treatment of articles, said installation comprising:
a) at least two treatment stations;
b) a conveying system by means of which the articles can be conveyed through a particular treatment station;
wherein
c) the conveying system comprises a main conveyor by means of which articles can be conveyed, without being treated, over a main circular route;
d) the at least two treatment stations are arranged along the main circular route;
e) the conveying system comprises an individual station conveying system for each of the at least two treatment stations, by means of which system articles can be conveyed from the main circular route to the treatment station, through the treatment station, and from the treatment station back onto the main circular route again, such that:
f) articles can be conveyed selectively, by means of a station conveying system, through the associated treatment station or, by means of the main conveyor, past said treatment station.

2. The installation according to claim 1, wherein at least one station conveying system comprises a handling arrangement by means of which articles can be transferred from the main conveyor to the treatment station.

3. The installation according to claim 2, wherein the main conveyor is a power-and-free conveyor.

4. The installation according to claim 1, wherein at least one treatment station comprises a cooling zone and the station conveyer of the said treatment station comprises a branch conveyor which connects said cooling zone, from the materials-handling point of view, to the main conveyor.

5. The installation according to claim 1, wherein at least one pre-treatment station is present.

6. The installation according to claim 1, wherein at least one powder-painting station is present.

7. The installation according to claim 1, wherein at least one wet-painting station is present.

8. The installation according to claim 1, wherein at least one top-coating station is present.

9. The installation according to claim 1, wherein at least one machining station is present, in which the articles can be mechanically machined.

10. The installation according to claim 9, wherein the machining station is a gloss-turning station.

11. The installation according to claim 1, wherein at least one separate cooling station and/or one pre-heating station is present.

12. The installation according to claim 1, wherein the articles are vehicle wheels.
